(19) United States
(12) Patent Application Publication
(10) Pub. No.: US 2005/0130663 A1
(43) Pub. Date: Jun. 16, 2005

(54) Apparatus and method for controlling a forward data rate in a mobile communication system

(76) Inventors: Ki-Seob Hong, Suwon-si (KR); Dong-Jun Lee, Suwon-si (KR); Sung-Kwon Jo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/996,051

(22) Filed: Nov. 24, 2004

(30) Foreign Application Priority Data
Nov. 28, 2003 (KE) 2003-85761

(51) Int. Cl. H04Q 7/20

(52) U.S. Cl. 455/445

(57) ABSTRACT

An apparatus and method for controlling a forward data rate by an access terminal in a mobile communication system having at least one access terminal and an access point capable of performing packet data communication with the access terminal. The apparatus and method comprise receiving packet data information including a target packet error rate (PER) from the access point over a forward link channel and decoding the received packet data information; adjusting target PERs for respective data rate control (DRC) values according to the decoded packet data information; selecting one of the adjusted target PERs according to the decoded packet data information, and determining the selected target PER as a target PER for a DRC value to be transmitted; estimating a carrier-to-interference ratio (C/I) for the received packet data information; and determining a DRC value satisfying the determined target PER using the estimated C/I.

### PRIORITY

This application claims the benefit under 35 U.S.C. § 119(a) to an application entitled “Apparatus and Method for Controlling Forward Data Rate in a Mobile Communication System” filed in the Korean Intellectual Property Office on Nov. 28, 2003 and assigned Serial No. 2003-85761, the entire contents of which are incorporated herein by reference.

### BACKGROUND OF THE INVENTION

1. Field of the Invention

The present invention relates generally to an apparatus and method for controlling a data rate in a mobile communication system. In particular, the present invention relates to an apparatus and method for controlling a data rate of a forward link by a mobile communication terminal such as an access terminal.

2. Description of the Related Art

Generally, in a 2^{nd} generation (2G) Code Division Multiple Access (CDMA) mobile communication system, a voice-oriented service is achieved through a relatively low-speed traffic channel in both the forward direction and the reverse direction. However, users demand advanced services rather than the simple voice-oriented service. In order to meet various users' demands, the 2G CDMA mobile communication system is evolving into an advanced mobile communication system capable of supporting data service as well as voice service.

As described above, the mobile communication system has evolved from a voice-oriented system into a 3^{rd} generation (3G) system that provides a high-speed data service. Research is being conducted on a system for enabling a data-oriented multimedia service.

For example, in 3^{rd} Generation Partnership Project 2 (3GPP2), a 1x Evolution-Data Only (1x EV-DO) standard or a High Data Rate (HDR) standard has been established in order to support a CDMA2000 1x standard-based data service. Such a system transmits only high-speed packet data with maximum power in the forward direction.

In a description of a 1x EV-DO forward link, a transmitter serves as an access point (AP) and a receiver serves as an access terminal (AT). A 1x EV-DO physical layer employing a link adaptation scheme supports 3 types of modulation schemes of Quadrature Phase Shift Keying (QPSK), 8-ary Phase Shift Keying (8PSK) and 16-ary Quadrature Amplitude Modulation (16QAM), 2 types of coding rates of 1/5 and 1/3, and 12 types of data rates according to the packet length.

In order to allow an access point to select a data rate of a forward link, an access terminal measures a carrier-to-interference ratio (C/I) of a forward pilot channel, selects a data rate available for a traffic channel according to the measurement result, and transmits feedback information on the selected data rate to the access point. The transmitted feedback data rate control information is defined as data rate control (DRC) information. The DRC information is transmitted over a DRC channel, and is expressed with a 4-bit DRC symbol.

An architecture for determining a forward data rate in the 1x EV-DO system will be described with reference to the accompanying drawing. In the conventional 1x EV-DO system, a forward data rate is determined such that a target packet error rate (PER) or frame error rate (FER) satisfies 1%.

FIG. 1 is a block diagram illustrating a system architecture for determining a forward data rate such that a target PER of 1% is achieved in a conventional CDMA2000 1x EV-DO system.

An access point (or access network) 10 of the 1x EV-DO system includes a DRC decoder 11 for decoding a DRC transmitted over a reverse link channel, an acknowledgement/negative acknowledgement (ACK/NAK) decoder 12 for decoding an ACK/NAK signal (or response signal) of a physical layer, and a scheduler 13 for scheduling allocation of forward resources according to the decoded information.

An access terminal 20 of the 1x EV-DO system includes a decoder 21 for receiving packet information over a forward link channel, a C/I estimator 22 for estimating a C/I from the received packet information, an ACK/NAK generator 23, a DRC decider 24 for determining a DRC according to the C/I value and a target PER, and a target PER decider 25 for setting a target PER to 1%.

The access terminal 20 transmits packet information over a forward link every 1.67 ms, and also transmits a pilot channel, or a reference channel, over the forward link every 0.38 ms. The access terminal 20 estimates a C/I of a forward link by demodulating a received signal, and determines a DRC value in which a target PER satisfies 1%, for all DRCs according to packet error information determined in the decoder 21. The access terminal 20 transmits the determined DRC value over a forward link, and at the same time, transmits ACK/NAK over a reverse link according to the packet error information determined in the decoder 21. The access point 10 then decodes the ACK/NAK and the DRC value received over the reverse link, and allocates forward resources according to the decoding result. The access point 10 and the access terminal 20 repeatedly perform the foregoing operation.

When a mobile communication terminal such as an access terminal uses a fixed target PER for a forward link as described above, forward resources can be used inefficiently. For example, for a forward link, a target PER of 1% requires higher transmission power than a PER of a higher percentage, causing a reduction in a transmission power gain in the forward link. When a target PER is increased to 5% in order to overcome this problem, if an inappropriate radio link protocol (RLP) retransmission is set up, transmission control protocol (TCP) throughput is reduced or affected according to the application type. Also, the current system architecture is designed such that the same target PER is used for all data rates, causing performance deterioration.

### SUMMARY OF THE INVENTION

It is, therefore, an object of the present invention to provide a forward data rate control apparatus and method for increasing quality-of-service (QoS) and system performance as well as a forward transmission power gain in a mobile communication system.

It is another object of the present invention to provide an apparatus and method for efficiently determining a data rate of a forward link by an access terminal by setting a different target packet error rate (PER) and controlling the number of radio link protocol (RLP) retransmissions according to a data rate control (DRC) value indicative of a data rate of a forward link in the access terminal.

According to a first aspect of the present invention, there is provided a method for controlling a forward data rate by an access terminal in a mobile communication system having at least one access terminal and an access point capable of performing packet data communication with the access terminal. The method comprises the steps of receiving packet data information including a target packet error rate (PER) from the access point over a forward link channel and decoding the received packet data information; adjusting target PERs for respective data rate control (DRC) values according to the decoded packet data information; selecting one of the adjusted target PERs according to the decoded packet data information, and determining the selected target PER as a target PER for a DRC value to be transmitted; estimating a carrier-to-interference ratio (C/I) for the received packet data information; and determining a DRC value satisfying the determined target PER using the estimated C/I.

According to a second aspect of the present invention, there is provided a method for controlling a forward data rate by an access point in a mobile communication system having at least one access terminal and the access point capable of performing packet data communication with the access terminal. The method comprises the steps of transmitting a target packet error rate (PER) message including a target PER and the number of retransmissions, set according to application type, to the access terminal over a forward link channel; receiving over a reverse link a data rate control (DRC) value determined according to a target PER selected from target PERs for respective DRC values, adjusted depending upon the transmitted target PER; and decoding the received DRC value and allocating resources according to the decoding result.

According to a third aspect of the present invention, there is provided a mobile communication system for controlling a forward data rate. The mobile communication system comprises an access point for transmitting a target packet error rate (PER) over a forward link channel according to application type, and allocating resources according to a received data rate control (DRC) value decoded according to the transmitted target PER; and an access terminal for decoding packet data information including a target PER, received from the access point over a forward link channel, adjusting target PERs for respective DRC values according to the decoded packet data information, selecting one of the target PERs adjusted according to the decoded packet data information, determining the selected target PER as a target PER for a DRC value to be transmitted, estimating a carrier-to-interference ratio (C/I) for the received packet data information, and determining a DRC value satisfying the determined target PER using the estimated C/I value.

According to a fourth aspect of the present invention, there is provided an apparatus for controlling a forward data rate in an access point capable of performing packet data communication with at least one access terminal in a mobile communication system. The apparatus comprises a target packet error rate (PER) generator for generating a target PER according to application type and transmitting the target PER to the access terminal over a forward link channel; a scheduler for allocating resources according to a received data rate control (DRC) value determined according to the transmitted target PER; and a DRC decoder for receiving over a reverse link a DRC value determined according to a target PER selected from target PERs for respective DRC values, adjusted depending upon the transmitted target PER, and decoding the received DRC value.

According to a fifth aspect of the present invention, there is provided an apparatus for controlling a forward data rate in an access terminal capable of performing packet data communication with at least one access point in a mobile communication system. The apparatus comprises a decoder for decoding packet data information including a target packet error rate (PER) received from the access point over a forward link channel; a carrier-to-interference ratio (C/I) estimator for estimating a C/I for the received packet data information; a plurality of target PER deciders for adjusting target PERs for respective data rate control (DRC) values according to the decoded packet data information, and determining a target PER for a DRC value to be transmitted; a target PER selector for selecting one target PER decider that determines a target PER for a DRC value to be transmitted among target PERs adjusted according to the decoded packet data information; and a DRC decider for determining a DRC value satisfying the determined target PER using the estimated C/I value, and transmitting the determined DRC value to the access point.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram illustrating a system architecture for determining a forward data rate such that a target packet error rate (PER) satisfies 1% in a conventional Code Division Multiple Access 2000 (CDMA2000) First Evolution Data Only (1x EV-DO) system;

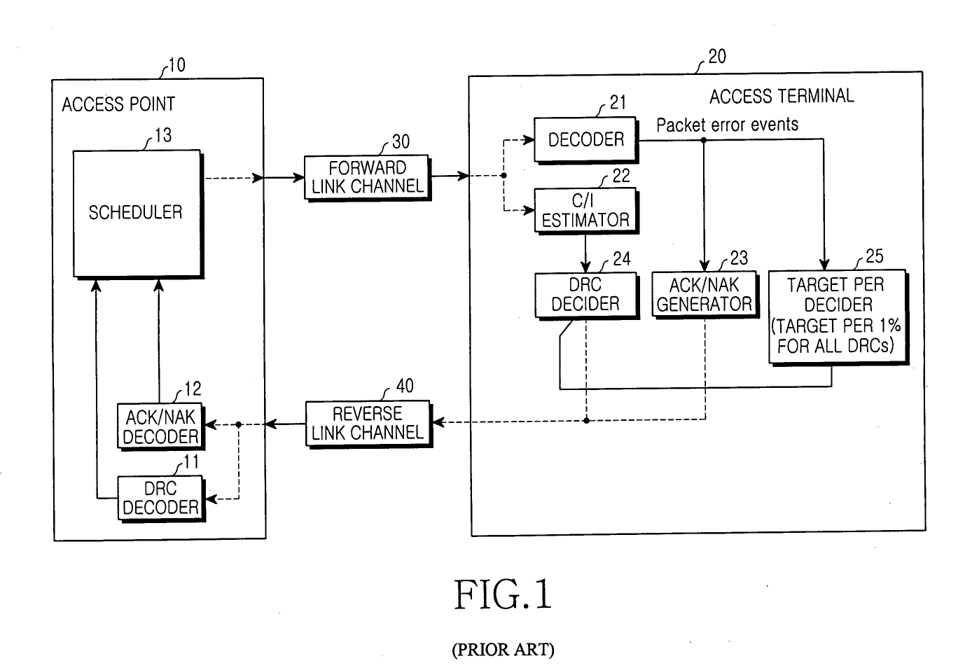

FIG. 2 is a block diagram illustrating a system architecture for efficiently determining a data rate of a forward link in a CDMA2000 1x EV-DO system according to an embodiment of the present invention;

FIG. 3 is a flowchart illustrating an operation of controlling a forward data rate in an access terminal for a mobile communication system according to an embodiment of the present invention;

FIG. 4 is a graph illustrating forward transmission power gains according to an embodiment of the present invention in which a target PER of 1% is changed to target PERs of 3% and 5% in an access terminal; and

FIG. 5 is a graph illustrating simulation results on transmission control protocol (TCP) throughput in a forward link by changing a target PER and the number of radio link protocol (RLP) retransmissions depending upon a data rate control (DRC) value indicative of a forward data rate according to an embodiment of the present invention.

### DETAILED DESCRIPTION OF THE PREFERRED EMBODIMENT

A preferred embodiment of the present invention will now be described in detail with reference to the accompanying drawings. In the following description, a detailed description of known functions and configurations incorporated herein has been omitted for conciseness.

The embodiment of the present invention will be described herein with reference to a First Evolution Data Only (1x EV-DO) system that controls decisions on a forward data rate by adjusting a target PER and the number of radio link protocol (RLP) retransmissions, rather than a general 1x EV-DO system that uses a target packet error rate (PER) or frame error rate (FER) of 1% for all data rate controls (DRCs). Although an embodiment of the present invention will be described with reference to the 1x EV-DO system, it can also be applied to other systems using a target PER of 1% for all DRCs.

First, a description will be made of an apparatus and method for determining a forward data rate in the Code Division Multiple Access 2000 (CDMA2000) 1x EV-DO system. Next, a description will be made of a method for determining a forward data rate when a target PER of 1% is changed to a target PER of 3% or 5% and the number of RLP retransmissions is adjusted, and made of simulation results thereof.

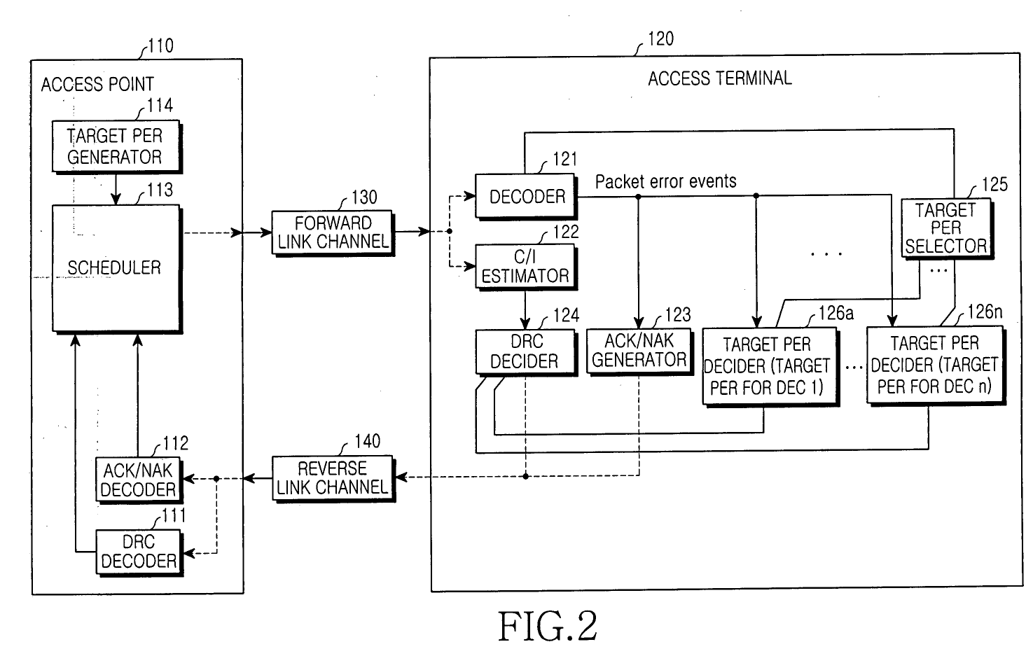

FIG. 2 is a block diagram illustrating a system architecture for effectively determining a DRC value indicative of a data rate of a forward link in a CDMA2000 1x EV-DO system according to an embodiment of the present invention.

Referring to FIG. 2, an access point 110 of the 1x EV-DO system includes a DRC decoder 111 for decoding DRC transmitted over a reverse link channel 140, an ACK/NAK decoder 112 for decoding ACK/NAK of a physical layer, and a scheduler 113 for scheduling allocation of forward resources according to the decoded information. Further, the access point 110 includes a target PER generator 114 connected to the scheduler 113, for generating a target PER message including a target PER and transmitting the target PER message to an access terminal 120.

The access terminal 120 includes a decoder 121 for receiving packet information including a target PER over a forward link channel 130, a carrier-to-interference ratio (C/I) estimator 122 for estimating a C/I from the received packet information, an ACK/NAK generator 123 for informing the access point 110 as to whether there is an error in the packet information over the reverse link channel 140, and a plurality of DRC deciders 124 for determining a DRC according to the C/I value and the target PER. Further, the access terminal 120 includes target PER deciders 126a to 126n for determining a target PER in order to determine a DRC by adjusting a target PER to 1% or higher according to each DRC, and a target PER selector 125 for selecting one of the target PER deciders 126a to 126n.

The target PER deciders 126a to 126n receive reports on packet error events from the decoder 121. The target PER selector 125 transmits a target PER to a corresponding target PER decider according to a received target PER.

An operation of controlling a forward data rate in the mobile communication system having the foregoing architecture will be described herein below.

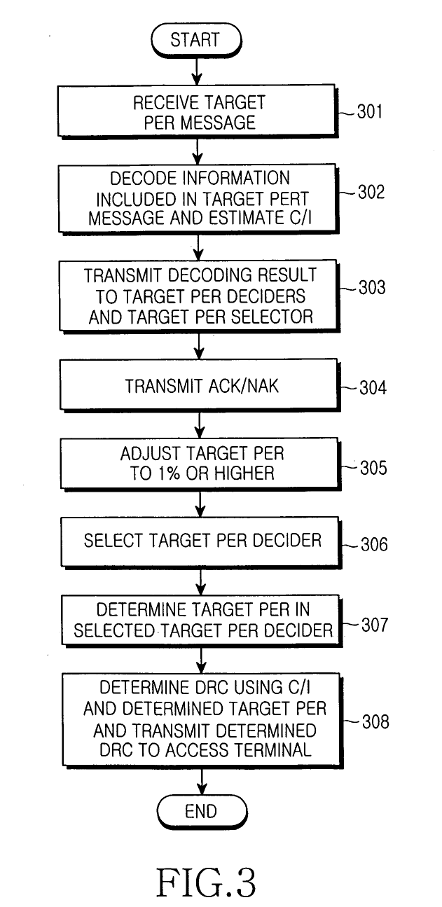

FIG. 3 is a flowchart illustrating an operation of controlling a forward data rate in a mobile communication system according to an embodiment of the present invention.

The access point 110 generates a target PER message including a target PER and the number of RLP retransmissions in the target PER generator 114, and transmits the target PER message to a particular access terminal or all access terminals over the forward link channel 130 via the scheduler 113 when necessary, i.e., according to application type. Here, the access point 110 transmits packet information over a forward link every 1.67 ms, and also transmits a pilot channel, or a reference channel, over the forward link every 0.38 ms.

The access terminal 120 then sets a target PER for each DRC value according to a target PER for a DRC value received from the access point 110 through the garget PER message, and sets the number of RLP retransmissions using an RLP retransmission count message. That is, referring to FIG. 3, in step 301, the access terminal 120 receives the target PER message from the access point 110, and inputs the received target PER message to the decoder 121 and the C/I estimator 122.

In step 302, the decoder 121 decodes a signal received from the access point 110, i.e., decodes information on the target PER message, and the C/I estimator 122 estimates a C/I of the received signal.

Thereafter, in step 303, the decoder 121 transmits the decoding result to the target PER deciders 126a to 126n and the target PER selector 125. In other words, the decoder 121 detects a PER set by the access point 110 from the decoding result, informs the target PER deciders 126a to 126n of the packet error event, and transmits the detected PER to the target PER selector 125. At the same time, the decoder 121 transmits the decoding result to the ACK/NAK generator 123.

In step 304, the ACK/NAK generator 123 transmits ACK/NAK to the access point 110 over the reverse link according to the detected packet error through an ACK/NAK operation. Then, the ACK/NAK decoder 112 in the access point 110 decodes received ACK/NAK and transmits the decoding result to the scheduler 113. During the decoding operation, the C/I estimator 122 estimates a C/I of the forward link and transmits the estimation result to the DRC deciders 124.

Thereafter, in step 305, the target PER deciders 126a to 126n in the access terminal 120 receive packet error event information from the decoder 121, and adjust a target PER to 1% or higher so that a target PER for a DRC value indicative of a forward data rate can be satisfied, according to the received packet error event information.

In step 306, the target PER selector 125 of the access terminal 120 selects one of the target PER deciders 126a to 126n. In step 307, a target PER decider selected by the target PER selector 125 determines a target PER for a DRC value indicative of the forward data rate, and transmits information on the determined target PER to the DRC deciders 124.

In step 308, the DRC deciders 124 in the access terminal 120 determine a DRC value using the estimated C/I and the target PER determined by the selected target PER decider, and transmits the determined DRC value to the access point 110 over the reverse link channel 140. At the same time, the ACK/NAK generator 123 transmits ACK/NAK over the reverse link according to a packet error detected by the decoder 121. The access point 110 decodes the ACK/NAK and the DRC value received over the reverse link, and allocates forward resources according to the decoding result. The foregoing operation is repeatedly performed.

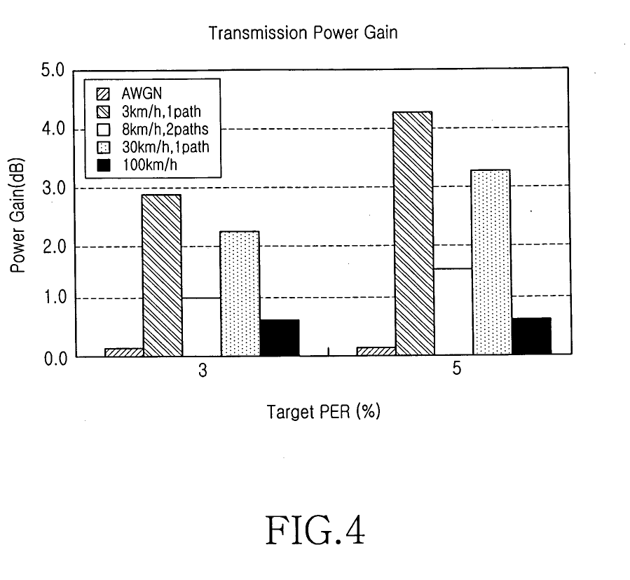

FIG. 4 is a graph illustrating forward transmission power gains according to an embodiment of the present invention in which a target PER of 1% is changed to target PERs of 3% and 5% in a mobile communication terminal. The results of FIG. 4 are illustrated in Table 1.

TABLE 1

Transmission Power Gain (dB)

| Channel Model | Target PER 3% | Target PER 5% |
|---|---|---|
| AWGN | 0.1 | 0.1 |
| 3 Km/h, 1 path | 2.9 | 4.3 |
| 8 Km/h, 2 paths | 1.0 | 1.5 |
| 30 Km/h, 1 path | 2.3 | 3.3 |
| 100 Km/h, 3 paths | 0.6 | 0.8 |

FIG. 4 and Table 1 illustrate forward transmission power gains in Access Terminal Minimum Performance Specification provided by 3^{rd} Generation Partnership Project 2 (3GPP2), in which a target PER of 1% is changed to target PERs of 3% and 5%. Here, a target PER in an Additive White Gaussian Noise (AWGN) environment was calculated for all data rates, and target PERs in the remaining fading environments were calculated for data rates of 38.4 Kbps and 76.8 Kbps.

Referring to Table 1, in the case of AWGN, when the target PER is changed, a transmission power gain is reduced to 0.1 dB. However, when there is slow fading and the number of forward transmission paths is smaller, the transmission power gain is obtained. For example, in the case of “3 Km/h, 1 path” which corresponds to a pedestrian walking velocity, when target PERs of 3% and 5% are used instead of the target PER of 1%, transmission power gains of 2.9 dB and 4.3 dB are obtained on average, respectively.

However, if a target PER is increased in the current commercial network, TCP throughput is reduced as compared with when the target PER is 1%. To solve this problem, in the current 1x EV-DO system, the number of RLP retransmissions is set to 1. Therefore, in the embodiment of the present invention, it is possible to prevent a reduction in TCP throughput by controlling the number of RLP retransmissions.

In order to examine a variation in TCP throughput in a forward link by changing the target PER and the number of RLP retransmissions according to a DRC value indicative of a forward data rate in the foregoing method, simulation results will be described with reference to the accompanying drawing.

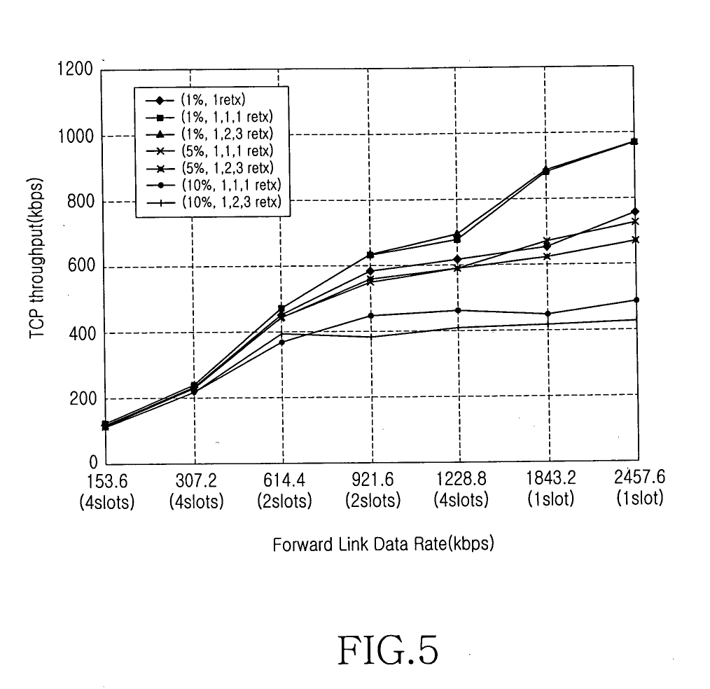

FIG. 5 is a graph illustrating simulation results on TCP throughput in a forward link by changing a target PER and the number of RLP retransmissions depending upon a DRC value indicative of a forward data rate according to an embodiment of the present invention.

The simulation results were obtained in an environment where packet errors were randomly generated for a fixed DRC value at the target PER and the number of RLP retransmissions was changed. Here, end-to-end wire-line Round Trip Delay (RTD) is set to 100 ms, and TCP segment payload is set to 520 bytes. In addition, legends illustrated in FIG. 5 represent the target PER and the number of RLP transmissions on NAK per RLP retransmission. For example, “(1%, 1,2,3 retx)” indicates that the target PER is 1%, the number of retransmissions is 3, and NAK per RLP retransmission is transmitted 1, 2 and 3 times.

Referring to FIG. 5, it can be understood that an example of (5%, 1,1,1 retx) where a target PER is 5% and the number of RLP retransmissions is 3 shows similar performance to that of the current commercial network (1x EV-DO network) in which a target PER is 1% and the number of RLP retransmissions is 1. In addition, it can be noted that an example of (1%, 1,1,1 retx) where a target PER is 1% and the number of RLP retransmissions is 3 shows similar performance to that of the current commercial network at 614.4 Kbps or lower.

From the simulation results, the following facts can be obtained. If it is assumed that the number of RLP retransmissions is set to 3 in the current commercial network, as a target PER increases at 614.4 Kbps or higher, the current architecture using the same target PER for all DRCs cannot obtain a transmission power gain at a data rate where performance is reduced. However, architecture having a different target PER according to DRC can obtain a transmission power gain by using a different target PER according to a data rate.

As described above, if the target PER is increased to 1% or higher according to a DRC value and the number of RLP retransmissions is controlled, a decrease in TCP throughput at each DRC value is prevented, obtaining a forward transmission power gain. The 1x EV-DO system according to an embodiment of the present invention has architecture for avoiding an influence on applications by controlling a target PER according to application type. For example, an application requiring real-time processing is susceptible to a delay although it is insusceptible to data error. Therefore, a target PER is set low and the number of RLP retransmissions is set to 1 or 0, thereby minimizing a time delay. However, Hyper Text Transfer Protocol (HTTP) or File Transfer Protocol (FTP) is susceptible to data error although it is insusceptible to a delay. Therefore, a target PER is increased and the number of RLP retransmissions is set to 3 or an appropriate value, thereby increasing a forward data rate. The use of the foregoing method can increase the overall forward data rate and service-of-quality (QoS).

As described above, the embodiment of the present invention can obtain a transmission power gain and prevent performance deterioration by changing a target PER for a DRC value indicative of a forward data rate and controlling the number of RLP retransmissions, thereby contributing to an increase in a forward data rate required by an access terminal.

In addition, the embodiment of the present invention maintains QoS and increases a forward data rate by controlling a target PER and the number of RLP retransmissions according to application type, thereby improving the overall performance of the mobile communication system.

While the invention has been shown and described with reference to a certain embodiment thereof, it should be understood by those skilled in the art that various changes in form and details may be made therein without departing from the spirit and scope of the invention as defined by the appended claims.

1. A method for controlling a forward data rate by an access terminal in a mobile communication system having at least one access terminal and an access point capable of performing packet data communication with the access terminal, the method comprising the steps of:
receiving packet data information including a target packet error rate (PER) from the access point over a forward link channel and decoding the received packet data information;
adjusting target PERs for respective data rate control (DRC) values according to the decoded packet data information;
selecting one of the adjusted target PERs according to the decoded packet data information, and determining the selected target PER as a target PER for a DRC value to be transmitted;
estimating a carrier-to-interference ratio (C/I) for the received packet data information; and
determining a DRC value satisfying the determined target PER using the estimated C/I.

2. The method of claim 1, further comprising the step of adjusting the number of retransmissions according to the decoding result on the received packet data information, and requesting the access point to perform retransmission as many times as the adjusted number of retransmissions.

3. A method for controlling a forward data rate by an access point in a mobile communication system having at least one access terminal and the access point capable of performing packet data communication with the access terminal, the method comprising the steps of:
transmitting a target packet error rate (PER) message including a target PER and the number of retransmissions, set according to application type, to the access terminal over a forward link channel;
receiving over a reverse link a data rate control (DRC) value determined according to a target PER selected from target PERs for respective DRC values, adjusted depending upon the transmitted target PER; and
decoding the received DRC value and allocating resources according to the decoding result.

4. A mobile communication system for controlling a forward data rate, comprising:
an access point for transmitting a target packet error rate (PER) over a forward link channel according to an application type, and allocating resources according to a received data rate control (DRC) value decoded according to the transmitted target PER; and
an access terminal for decoding packet data information including a target PER, received from the access point over a forward link channel, adjusting target PERs for respective DRC values according to the decoded packet data information, selecting one of the target PERs adjusted according to the decoded packet data information, determining the selected target PER as a target PER for a DRC value to be transmitted, estimating a carrier-to-interference ratio (C/I) for the received packet data information, and determining a DRC value satisfying the determined target PER using the estimated C/I value.

5. The mobile communication system of claim 4, wherein the access terminal adjusts the number of retransmissions according to the decoding result on the received packet data information, and requesting the access point to perform retransmission as many times as the adjusted number of retransmissions.

6. An apparatus for controlling a forward data rate in an access point capable of performing packet data communication with at least one access terminal in a mobile communication system, the apparatus comprising:
a target packet error rate (PER) generator for generating a target PER according to application type and transmitting the target PER to the access terminal over a forward link channel;
a scheduler for allocating resources according to a received data rate control (DRC) value determined according to the transmitted target PER; and
a DRC decoder for receiving over a reverse link a DRC value determined according to a target PER selected from target PERs for respective DRC values, adjusted depending upon the transmitted target PER, and decoding the received DRC value.

7. The apparatus of claim 6, further comprising an acknowledgement/negative acknowledgement (ACK/NAK) decoder for decoding an ACK/NAK signal according to the decoding result on the transmitted packet data information.

8. An apparatus for controlling a forward data rate in an access terminal capable of performing packet data communication with at least one access point in a mobile communication system, the apparatus comprising:
a decoder for decoding packet data information including a target packet error rate (PER) received from the access point over a forward link channel;
a carrier-to-interference ratio (C/I) estimator for estimating a C/I for the received packet data information;
a plurality of target PER deciders for adjusting target PERs for respective data rate control (DRC) values according to the decoded packet data information, and determining a target PER for a DRC value to be transmitted;
a target PER selector for selecting one target PER decider that determines a target PER for a DRC value to be transmitted among target PERs adjusted according to the decoded packet data information; and
a DRC decider for determining a DRC value satisfying the determined target PER using the estimated C/I value, and transmitting the determined DRC value to the access point.

9. The apparatus of claim 8, further comprising an acknowledgement/negative acknowledgement (ACK/NAK) generator for adjusting the number of retransmissions according to the decoding result on the received packet data information and transmitting an ACK/NAK signal to the access point.
